(19) United States
(12) Patent Application Publication
(10) Pub. No.: US 2010/0057575 A1
(43) Pub. Date: Mar. 4, 2010

(54) Content Detection and Payment System

(75) Inventors: Lee Begeja, Gillette, NJ (US); David C. Gibbon, Lincroft, NJ (US); Paul van Vleck, Austin, TX (US)

Correspondence Address: AT & T LEGAL DEPARTMENT - PG, ATTN: PATENT DOCKETING , ROOM 2A- 207, ONE AT &T WAY, BEDMINSTER, NJ, 07921, US

(73) Assignee: AT&T Labs, Inc., Austin, TX (US)

(21) Appl. No.: 12/204,176

(22) Filed: Sep. 4, 2008

(51) Int. Cl. G06Q 30/00; G06Q 20/00; G06Q 90/00

(52) U.S. Cl. 705/14.66; 705/400

(57) ABSTRACT

Systems and techniques for detecting presentations of sponsored content and identifying persons bearing the content. A set of sponsored content items is identified for which a bearer presenting the content item in qualifying ways may receive payment, and a group of participating users is established, with information being stored for the users so as to allow for identification of a user presenting a content item in order to direct proper credit to the user making the presentation. A plurality of video feeds are identified and monitored and any video feed in which a sponsored logo appears is further examined to identify a bearer of the content item. Upon identification of the bearer, presentation of the content item is evaluated and appropriate payment is calculated. Details of content item presentations and payments may be stored in connection with users and evaluated to provide insight into the circumstances surrounding and influencing presentations.

### FIELD OF THE INVENTION

The present invention relates generally to improved systems and techniques for content detection. More particularly, the invention relates to improved systems and methods recognizing the presence of a specified content item, such as a logo, slogan, distinctive pattern, or other advertising or promotional materials or other materials to which it is desired to draw attention, along with the identity of the bearer of the content item, to facilitate payment to the bearer for appearing with, or presenting, the item.

### BACKGROUND OF THE INVENTION

One useful aspect of advertising and promotion by organizations, such as corporations promoting their name or product, is the use of advertising materials, such as organization or product logos, distributed to members of the public. Many organizations benefit from the promotion that they receive when their advertising materials are worn or otherwise displayed at public events. It is possible to induce members of the public to display such materials by offering them compensation, such as cash payments or points that can be redeemed for services or merchandise, in exchange for wearing or otherwise displaying materials such as a logo or other promotional item or materials in an appropriately public venue. While the cumulative benefit to the organization may be large, the benefit from any individual appearance of the promotional item is small, so payment for any such individual appearance must likewise be small. The benefit to the member of the public displaying a promotional item will result from an accumulation of payments for multiple appearances.

### SUMMARY OF THE INVENTION

Among its several aspects, the present invention recognizes and addresses a number of problems surrounding the recognition of specific content, such as advertising or promotional materials. An example of a content item is a logo, and one or more aspects of the present invention address the recognition of a logo or other content item presented by a member of the public and the identification and payment of such a member of the public, and provides for a convenient, automated mechanism for managing recognition and payment. The invention recognizes that in order for a payment system to be sufficiently practical to allow meaningful compensation to members of the public, transaction costs of recognizing the appearance of the logo and making payment must be kept as small as possible. Such a requirement raises the importance of automating recognition of a content item, association of the content item with a particular individual, identifying the individual, associating the individual with a payment mechanism, and crediting payment. In addition, the inconvenience to the individual being paid must be minimized or eliminated, or the payment will not be worth the inconvenience.

A number of problems are presented by any payment system involving small individual payments to members of the public for displaying logos or other promotional or advertising items or materials. The logo must be identified, the logo must be matched to a payment account to be credited for display of the logo, the amount to be paid for a display must be determined, and payment must be credited. All of these steps must be accomplished with a minimum of cost and inconvenience. The present invention addresses these problems, as well as others, by providing for systems and techniques for automatic recognition of a logo appearing in association with a person, such as being worn on or as part of an article of clothing. Recognition of a logo presented appearing in association with a person is accompanied by identification of the person sufficiently to associate the appearance of the logo with a payment account established for that person. Automatic pattern recognition techniques may be used to identify the logo. Alternatively, or in addition, each logo may include indicia identifying the nature of the logo. In addition, the logo may include a unique identifier that can be associated with an individual bearer or account. Alternatively, or in addition, a person bearing the logo may be provided with separate identifying indicia, or facial recognition techniques may be used to identify the bearer.

Determination of payment may be based on a number of factors, such as the presence of the logo at a particular event, the number of logos the bearer is carrying, the specific embodiment of each logo, such as whether the logo is a larger or smaller version, or whether or not the logo includes particular attention drawing attributes, such as prominent colors, flashing light emitting diodes (LEDs) or other characteristics. Additional considerations include the degree of visibility of the logo as presented by the bearer and the length of time the logo is visible in particular positions, such as displayed near a performance stage or playing field, on a large display screen visible to the audience at an events or in a television shot of a portion of the audience, with the prominence of the logo and the breadth of visibility of the display being used to influence payment.

When a logo is identified, steps may be taken to identify the bearer. A number of approaches are available, such as interpreting unique features present in the logo and associated with the bearer, interpreting an identifier issued to the bearer at entry into the venue hosting an event, or any number of other approaches. When the logo and the bearer have been identified, the instance of appearance of the logo is recorded and appropriate payment is computed. At desired intervals, credit is issued to the bearer's account.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system for recognizing and crediting presentations of content items according to an aspect of the present invention; and

FIG. 2 illustrates a process for recognizing and crediting content item presentations according to an aspect of the present invention.

### DETAILED DESCRIPTION

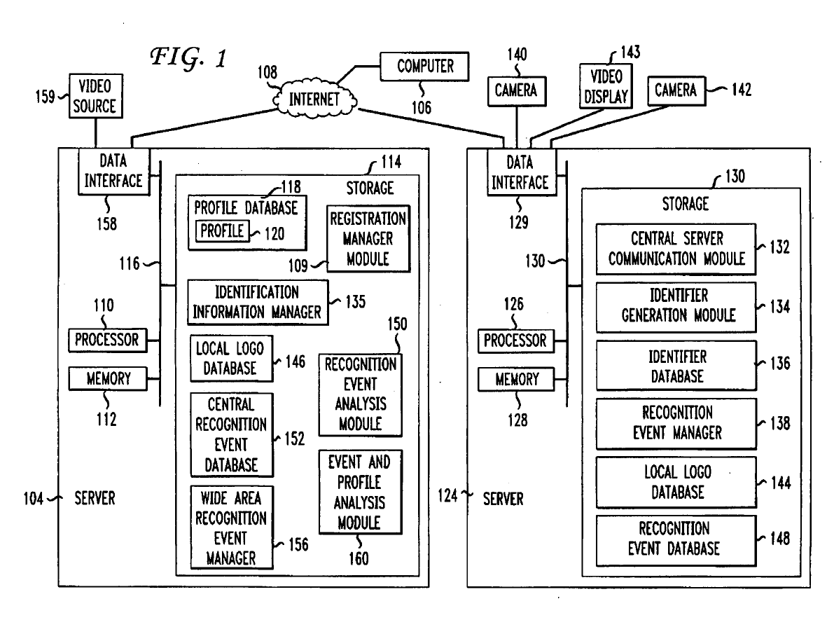

FIG. 1 illustrates a system 100 for recognizing and compensating content item appearances, such as logo appearances according to an aspect of the present invention. The system 100 includes a central server 104, suitably communicating with a user device such as a computer 106 through a publicly accessible medium such as the Internet 108. The server 104 may suitably include a processor 110, memory 112, and storage 114, communicating over a bus 116. The server 104 maintains a user profile database 118 storing user details for each of a plurality of users. User details may include name, address, and information identifying financial or reward accounts into which payment is to be made, and other desired details. For example, a user appearance and payment record may be accumulated and made accessible to the user for review, or used to calculate additional rewards based on meeting specified criteria, or as a basis for promotions. User details for a particular user may be stored in a user profile such as the profile 120.

The server 104 may be made accessible to interested users through the Internet 108, with users navigating to a site maintained to allow users to obtain information about the system 100 and to sign up for participation in programs maintained using the system 100. For example, a registration manager module 109 may present a registration website and may collect information entered through the website to establish a user account. A user may provide identifying information upon signup and may be issued an identifier, with various pieces of wearable identification material being mailed to the user or otherwise provided to the user. The user may wear such identification material at events at which payments may be earned to render user identification easier.

The server 104 may also be used to gain access to notifications of upcoming events at which payment can be earned and sponsors underwriting payment for displaying their logo. The server 104 may further be used to gain access to opportunities to order clothing or other items hearing sponsor logos, with such items being purchased through monetary transactions at full or discounted prices, provided free, provided in exchange for reward points, provided to users who are significant earners but without requiring the redemption of points, or obtainable according to whatever criteria may be desired. The server 104 may also support the retrieval of user identification information by data processing equipment at venues at which logo recognition is being conducted. For example, if a user has supplied a photograph, a user image may be made available for facial recognition. In addition or as an alternative, a user identifying himself or herself at entry to a venue at which an event is taking place may receive identification materials specific to the venue or the event, and an identifier associated with these identification materials may correlated with a user profile associated with the proper user. Each appearance of a logo will be analyzed to determine the appropriate payment and the user to whom payment is due, and the user profile 120 and other user profiles will be updated with an appropriate payment credit. At suitable intervals, payments that have been earned will be credited to user accounts.

A number of venue servers such as a server 124 will communicate with the central server 104, suitably through the Internet 108. The venue server 124 includes a processor 126, memory 128, storage 129, and data interface 130, communicating over a bus 131. The venue server 124 may employ a central server communication module 132, which may suitably be implemented as software hosted in storage 129 and transferred to memory 128 as necessary for execution by the processor 126. The venue server 124 also maintains an identifier generation module 134, suitably implemented as software, which manages issuance of local identifiers to attendees and correlates the local identifiers with primary identifiers maintained by the server 104. The identifier generation module 134 may suitably communicate with an identification information manager 135 operating in the server 104, which provides appropriate identification information for users upon request from the identifier generation module 134 so that the identifier generation module 134 can associate its own locally generated identifiers with the centrally stored information for a user. The identifier generation module 134 may suitably maintain an identifier correlation database 136 associating local issued identifiers with primary identifiers for the users to whom the local identifiers were issued.

The venue server 124 further maintains a recognition event manager 138, suitably implemented as software. The recognition event manager 138 receives visual data from one or more cameras such as the cameras 140 and 142, as well as the video feed from a display screen 143, and processes the information to create recognition events, with each recognition event being associated with an identifier that can in turn be associated with a user's profile such as the profile 120.

The recognition event manager 138 may suitably use visual processing techniques to detect sponsored logos and may use further visual processing techniques to identify the bearer of the logo. The recognition event manager 138 may have access to a local logo database 144, storing details of logos for which payment will be made for display at the local event. The local logo database 144 may be drawn from the server 104, and may represent a subset of logos stored in a general logo database 146 maintained by the server 104. The general logo database 146 may receive and store details of all logos currently recognized by the system 104. If desired, the recognition event manager 138 may communicate with the server 104 to perform recognition against the database 146, but the local database 144 can be expected to provide for faster and more efficient processing because the number of logos against which recognition is to be made will be smaller.

As each frame is delivered from the cameras 140 and 142 and to the video screen 143, the recognition event manager 138 analyzes the frame, comparing the frame against image data for qualifying logos stored in the database 144 or 146. When a qualifying logo is recognized, the recognition event manager 138 examines the frame in which the recognition occurred, and preceding and following frames, to identify the bearer of the logo. The recognition event manager may examine the bearer for an identifier, which may come in the form of a badge, clothing patch or design, or other item, and may bear a pattern representing an encoded identifier. The pattern may be a bar code or may be a more decorative pattern having distinctive and decodable features. As an alternative to detecting and decoding an encoded identifier, the recognition event manager 138 may perform facial recognition. In order to assist facial recognition, one or more images of each participating attendee may be captured and stored in the identifier correlation database 136, with the attendee's image being associated with his or her identifier taken from a profile stored in the user profile database 118. Such image capture and storage allows for facial recognition to be performed against a smaller pool of candidate images of persons, all of whom are known to have entered the venue for the event. Captured images may be analyzed and gross features of the images identified. For example, if a captured image shows an attendee wearing a red shirt and blue pants, those characteristics may be stored in a record associated with the attendee. When image recognition is performed on an image of a person appearing in a frame, corresponding gross features may be identified and a preliminary exclusion may be made of attendees whose identified gross features conflict with those appearing in the image under consideration.

In addition to identifying the appearance of a logo and associating the appearance with the bearer of the logo, the recognition event manager 138 also analyzes the nature of the appearance. The recognition event manager 138 associates the logo with a paying sponsor associated with the logo in the local logo database 144 or the general logo database 146. The databases 144 and 146 may include payment rules established by the sponsor of the logo or by the party maintaining the system 100, and these rules may be tailored to each venue or event in connection with which payment is to be managed.

Rules may relate to characteristics such as the size of the logo, the prominence of the positioning of the logo as positioned, or the presentation of the logo so as to draw attention. For example, a higher payment may be merited if the logo strongly contrasts with the background presented by the bearer, as may occur, for example, in the case of a white logo on a black jacket. A higher payment may also be merited if the logo includes features such as flashing lights or moving parts. Payment may also be influenced by the positioning of the logo in prominent positions at the venue, and the length of time the logo is visible in these positions, with a much higher payment being merited if the logo appears on the video display screen 143.

As a logo is identified in each frame from the cameras 140 and 142 and the feed serving the display screen 143, the presentation of the logo is evaluated according to the applicable rules. First, the absolute size of the logo may be evaluated. Some logos may include encoded information that can be decoded to determine their various features of interest, and such features may include size, color, and special features. In the absence of or in addition to evaluation based on such encoded information, the logo can be evaluated with respect to its surroundings. For example, the outline of the bearer of the logo may be identified, so as to distinguish the bearer from his or her surroundings, and the size of logo may be evaluated against the size of the bearer, for example, by dividing the bearer's image into segments and noting the number of segments occupied by the logo. In addition, the frame as a whole may be divided into segments and the number of segments occupied by the logo may be counted. Duration of appearance of the logo may also be taken into account. Image data is captured as a succession of frames, and one way of measuring the duration of the appearance of the logo is to count the successive number of frames in which the logo appears.

An additional factor that may be used to influence payment is the number of logos presented. A single individual may be wearing or otherwise carrying a number of instances of a logo, such as one logo on a hat, one logo on a jacket, one logo on a button, and so on. The logos may be multiple instances of the same logo, multiple complementary logos for a single sponsor, several logos for different products from the same sponsor, or different logos from different sponsors. Analysis if the presentation of a logo may include isolation of the image of the bearer and examination of the image for multiple logos. The payment merited may be computed taking into account the presence of multiple logos and the prominence of each, with appropriate rules being applied for multiple logos. For example, the additional payment earned for adding a second logo may be much less than 100% of the payment for the first logo, with payment for additional logos being further reduced. To take another example, payment from each sponsor may be reduced if a bearer displays logos from multiple sponsors.

Once appropriate payment has been computed, the recognition event manager 138 may create a recognition event record and store the record in a recognition event database 148. At a suitable time, such as at the end of the event, the records recorded in the recognition event database 148 may be transferred to the server 104 for examination by a recognition event analysis module 150 and storage in a central recognition event database 152. The recognition event analysis module 150 suitably transfers appropriate details for each recognition event to the profile of the user for whom the recognition was recorded. Such details may suitably include the data and time of the event and the venue, the logo or logos displayed, the particular appearance triggering the event, such as near the stage at a concert, or on the display screen at a sporting event. Details may also include characteristics that enhance or reduce payment, as well as the payment earned. The user profile for a user may also include records indicating accumulated payment earned, as well as payments credited to the user's account. In addition to recognizing presentation of logos at events, the system 100 may be used to recognize presentation of logos in more general ways. For example, the system 100 may monitor or otherwise receive information related to video feeds broadcast over television, or over the Internet 108. For example, in addition to monitoring performed by the recognition event manager 138, a wide area recognition event manager 156 may be hosted by the server 104 and may have access to numerous communication feeds through a data interface 158, illustrated here as receiving feeds from a video source 159 and the Internet 108. In one example, the manager 156 may monitor a broadcast video feed taken by a broadcasting network covering the same event at which the cameras 140 and 142 and the display screen 143 are used. If desired, recognition event processing may be performed by one or more centralized servers, such as the server 104, or other servers remote from a venue being monitored. For example, the cameras 140 and 142 may have access to a network, and all video feeds recording events at the venue may be processed by the wide area recognition event manager 156, or other suitably processing elements hosted on hardware remote from the venue whose events are of interest.

An example of such a broadcast video feed would be a broadcast of a sporting event, and the broadcast video feed would typically include crowd shots that could be monitored for the presentation of logos of interest. An appearance of a logo in such a video feed would be expected to have a high value and could be compensated accordingly, taking into account the viewership of the event. In addition to monitoring a specific video feed related to a particular venue in which the presentation of logos by users is being monitored, the manager 156 may also be used to detect and evaluate the appearance of logos of interest in additional data sources, such as more general broadcast feeds and sources such as the Internet 108. The manager 156 may receive broadcast feeds from broadcast networks covering events at which users are likely to appear. If sufficient processing resources are available, a broader range of feeds may be monitored, such as all available broadcast feeds of live events and activities. In addition, the manager 156 may direct the examination of sources of data such as video posting sites, of which a notable example is YOUTUBE™. Video clips of interest, such as video clips of events likely to draw attendance by users, and having a high number of views, may be examined to determine if logos of interest and their users can be identified. Many video posting sites, such as YOUTUBE™, accommodate the addition of descriptive tags, and such tags may be examined to identify clips of interest. For example, users posting their own videos may tag or otherwise label such videos with indications that they include presentations of logos using the system 100. In such cases, identification of the logo and user is simplified, and examination of the number of views achieved will indicate whether the video should be further examined in order to determine payment.

The server 104 may further include an event and profile analysis module 160. The event and profile analysis module 160 may suitably examine and analyze the records of recognition events stored in the database 152 and user profiles stored in the user profile database 118, in order to evaluate the recognition events and payments that have occurred, and to employ the records of recognition events and the user profiles in order to gain insight into the logo appearances and payment patterns and to identify the various factors that induce participants to participate more or less actively. Such analysis may be particularly useful in evaluating the likelihood of participation at different types of events. The number of recognition events at different venues may be noted and venues may be classified more or less precisely in relation to type of event, such a music concert or sporting event, geographic location of event, demographics of attendees, and the like. The number and value of recognition events at the various events may be compiled and statistics related to the number and value of recognition events may be correlated against statistics characterizing the nature and attendance of events and venues at which recognitions occur. In addition, various characteristics of the users may be examined. Such characteristics may include demographic, financial, and interest information relating to a user. Additional characteristics may include the number of venues attended by a user at which the user registers participation, and the number of recognition events recognized for the user, along with the value of each recognition event. Such statistics may be used, for example, to correlate demographic characteristics and interests of users with degree of participation and recognition events.

The operation of a system such as the system 100 may be illustrated by an example. An exemplary user employs the computer 106 to contact the server 104, invoking the registration manager module 109. The registration manager module 109 collects user information and establishes the user profile 120, storing the profile in the database 118. The profile includes identification information, financial information for receiving cash payments, and account information for receiving compensation such as reward points that may be exchanged for prizes. The profile may also include information relating to user interests, suitably collected through questionnaires that may be presented to the user. The user may invoke the registration manager module 109 whenever desired to modify the user information.

The user orders a set of identification information, including a badge with a decorative identifier, as well as logo gear from participants in the program. The logo gear includes hats from various vendors and shirts from the same vendors. One of the hats includes a logo with a unique identifier for the user embedded in the logo. The user also orders a registration card with a bar coded identifier for presentation at venues.

The user attends a concert at which he has been advised that payment will be made for presentation of logos of Superthirst soft drinks, Brilliant audio, and Ultrafast sports cars. The user wears his Superthirst shirt and his Ultrafast hat, and wears his identifier badge affixed to his shirt. At entry into the concert, the user presents his registration card, and his image is captured and his attendance noted. The user does not receive any venue specific registration identifiers, because he is carrying his standard identifier. The identification information collected from the user is stored in the identifier database 136.

The user is captured twice by the cameras at the concert, once by the camera 140 and once appearing on the video display 143. In the image taken by the camera 140, he appears for 5 seconds and his hat and shirt appear. The recognition event manager 138 performs image recognition on each of the logos and decodes the encoded identification on the identifier badge being worn by the user. An appropriate recognition event is logged in the recognition event database 148, with payment being made for each logo's appearance, without any reduction being made because the logos are not of competing goods and because they appear sufficiently far apart that reduction in impact due to multiple appearances is minimal.

On the video display 143, a headshot of the user appears, and the hat is displayed in the shot. The user's encoded identifier is not visible, but facial recognition is performed on the user and matched against the facial image captured in the identifier database 136. Facial recognition is simplified because only images including hats of the same color as that worn by the user are considered. The recognition event manager 138 captures an event and stores event information in the event recognition database 148, and appropriate compensation is calculated.

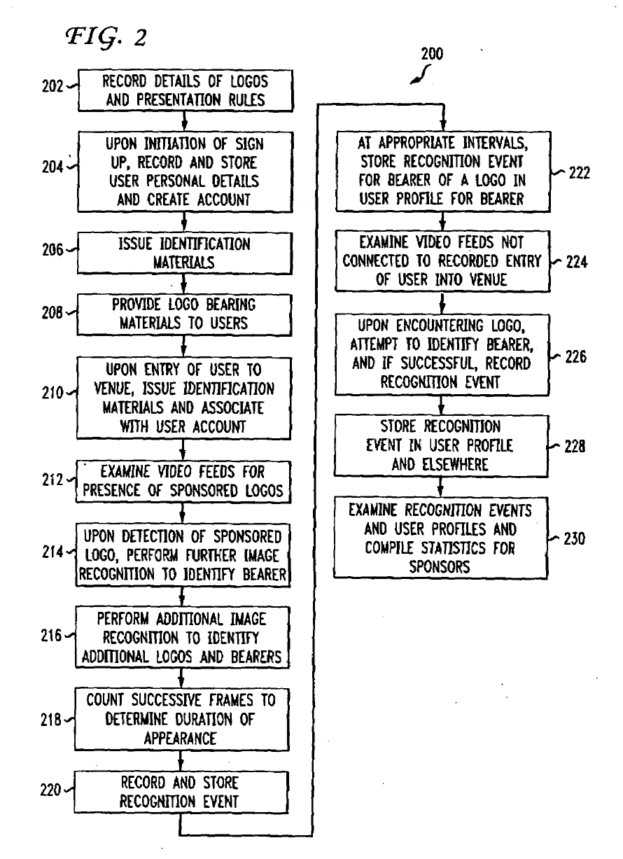

FIG. 2 illustrates the steps of a process 200 of logo presentation recognition and bearer identification and payment according to an aspect of the present invention. At step 202, details relating to of a plurality of logos of sponsors underwriting payment to users for display of their logos are recorded and rules are established governing payment for presentations. At step 204, upon initiation of a signup by each of a plurality of prospective users, personal details of the user are recorded and stored and an account is created for the user. Recording and storage of personal details may include capture of a user image for later image recognition, as well as demographic information, preference and interest information that may be submitted by the user in response to questions or surveys at signup or later, payment preferences, and financial details relating to payment accounts, as well as any additional relevant information. At step 206, identification materials are issued. Issuance of identification materials may include issuance of encoded clothing, badges, or other materials that can be read by image analysis techniques. At step 208, users are given the opportunity to purchase or to receive free of charge or in exchange for reward points materials bearing sponsor logos, and such materials are created and provided to the users. Such materials may include encoded indicia indicating various features of the logos, such as size, color, presence of attention catching devices, and other relevant characteristics. At step 210, at entry of a user into a venue hosting an event at which the user may earn compensation for presentation of one or more logos, identification of the user is optionally recorded and associated with a user account. Such identification may include recording an image of the user, and may further include identification of the user as being present at the venue.

At step 212, one or more video feeds are examined, suitably frame by frame, for the presence of sponsor logos for which payment for presentation may be earned. The video feeds may suitably be taken from cameras focused on prominent areas, from feeds serving large electronic displays, from broadcast feeds providing coverage of the venue or event, or from other feeds indicating a desired level of prominence for objects appearing in the images they represent. Examination of the video feeds may include the performance of image recognition on a frame, or a group of frames grouped according to appropriate criteria, such as a predetermined number of consecutive frames, and may be simplified if logos or identifiers include encoded information. At step 214, when a logo is identified in a frame, further image recognition is performed to identify the bearer of the logo, such as by decoding encoded identification material, or by facial recognition of the bearer. At step 216, further image recognition is performed on the frame to identify additional logos and bearers and the logos presented by each bearer.

At step 218, successive frames are examined to determine the duration of appearance of each logo in the video feed comprising the frames. At step 220, once the duration of an appearance of a logo presented by a particular bearer is determined, a recognition event is recorded for that bearer, with recording of the recognition event including determining and recording the payment earned for the presentation in question. At step 222, at appropriate intervals, each recognition event for a particular bearer is stored in a user profile for that bearer.

At step 224, conducted independently of steps 210-222, additional video feeds may be examined, not connected with any particular venue or a recorded entry of a bearer into a venue, one or more of a plurality of video sources are monitored according to various criteria used to search for presentations of logos by registered bearers, with the presentations exhibiting a sufficient level of prominence, such as television coverage of live events and news stories, or clips stored at video posting sites relating to desired subject matter and having sufficient numbers of views. At step 226, when a logo of interest is encountered, an attempt is made to identify the bearer as being associated with a user profile. When such a bearer is identified, the presentation of the logo by the bearer is evaluated and a recognition event is recorded. At step 228, the recognition event is stored in the user profile and elsewhere as appropriate. At step 230, at desired intervals, user profiles and recognition events are examined by or on behalf of owners of logos underwriting payment and appropriate statistics are compiled in order to evaluate the effectiveness of various forms of inducement and various presentation patterns that are exhibited.

While the present invention is disclosed in the context of a presently preferred embodiment, it will be recognized that a wide variety of implementations may be employed by persons of ordinary skill in the art consistent with the above discussion and the claims which follow below. For example, the discussion above has focused primarily on recognition of logos because it is to be expected that recognition of logos will be a significant use to which the teachings of the invention may be put, but the teachings of the present invention may easily be adapted to recognition of and compensation for many different forms of content.

We claim:

1. A system for detecting presentations of sponsored content and identifying and compensating the presenters, comprising:
a data interface for receiving one or more video feeds conveying images; and
a processor for analyzing the one or more video feeds to identify images of sponsored content appearing in the video feed, the processor being further operative, upon detection of sponsored content appearing on a video feed, to identify a user having the sponsored content on his or her person and credit an account associated with the user for appearing with the sponsored content in the video feed.

2. The system of claim 1, wherein the sponsored content is a promotional item whose appearance is being promoted by a sponsor.

3. The system of claim 2, wherein the processor is operative to perform image recognition of objects appearing in the frame against stored images of sponsored promotional items for which credit may be earned.

4. The system of claim 2, wherein the processor is operative to examine the images in the video feed for the presence of encoded information providing descriptive information relating to a sponsored promotional item.

5. The system of claim 2, wherein the processor is operative to isolate an image of a person bearing the promotional item from the surroundings of the image and examine the image for encoded information identifying the person.

6. The system of claim 2, wherein the processor is operative to isolate an image of a person bearing the promotional item from the surroundings of the image and perform facial recognition on the image to identify the person.

7. The system of claim 6, wherein the processor is operative to perform facial recognition by comparing the image against a data pool of images captured at entry to a venue from which the video feed is originating.

8. The system of claim 7, wherein the processor is operative, before performing facial recognition, to reduce the data pool of images by excluding images exhibiting gross features differing from those of the captured image.

9. The system of claim 2, further comprising data storage hosting a collection of user profiles of users, with each user profile including identifying information for the user, identification of the user including matching information received from the video feed with stored identifying information taken from the user profile.

10. The system of claim 2, wherein the processor is operative, upon recognizing a sponsored promotional item and a bearer of the promotional item, to evaluate the presentation of the content item in order to determine the payment earned by the presentation, the evaluation of the presentation including evaluating one or more of the size, prominence, and duration of display of the promotional item.

11. A method of detecting presentations of sponsored content and identifying and compensating the presenters, comprising:
examining one or more video feeds conveying images in order to detect the presence of sponsored content in the one or more video feeds;
upon detection of sponsored content appearing in the one or more video feeds, identifying a registered user bearing the sponsored content; and
determining a payment due to the bearer of the sponsored content for presentation of the sponsored content.

12. The method of claim 10, wherein the sponsored content is a promotional being promoted by a sponsor.

13. The method of claim 12, wherein the step of examining the one or more video feeds is preceded by a step of storing a collection of images of sponsored promotional items and wherein detecting the presence of a sponsored promotional item includes matching information provided by the one or more video feeds against stored information corresponding to a sponsored promotional item.

14. The method of claim 13, wherein detecting the presence of a sponsored promotional item includes performing image recognition on images in the one or more video feeds to match an image appearing in the one or more video feeds against a stored image of a sponsored promotional item.

15. The method of claim 12, wherein detecting the presence of a sponsored promotional item includes searching for encoded information displayed on an image of a promotional item and decoding the encoded information to extract information identifying and describing a particular sponsored promotional item.

16. The method of claim 12, wherein the step of examining the one or more video feeds is preceded by a step of storing user information in a user profile and wherein the step of identifying a bearer of a promotional item includes matching information provided by the one or more video feeds against stored information identifying the bearer.

17. The method of claim 16, wherein the step of identifying the bearer includes searching for encoded information displayed on an image of the bearer and decoding the encoded information to identify the bearer.

18. The method of claim 16, wherein the step of examining the video feeds is preceded by a step of receiving a reduced pool of user identification information indicating users expected to be at a venue from which the one or more video feeds are originating and wherein identification of a bearer includes matching information from the video feeds against the reduced pool of user identification information.

19. The method of claim 18, wherein the reduced pool of user identification information includes captured images of users expected to be at the venue and wherein identification of a bearer includes examining gross features of images appearing in the video feeds and excluding from consideration users whose images exhibit gross features differing from those exhibited by the video feeds.

20. The method of claim 12, wherein the step of determining payment due to a bearer of the promotional item includes evaluating presentation of the promotional item, evaluating presentation evaluating one or more of prominence of display, size of promotional item, and duration of presentation.
